(19) United States
(12) Patent Application Publication
(10) Pub. No.: US 2005/0134410 A1
(43) Pub. Date: Jun. 23, 2005

(54) Power addition apparatus, systems, and methods

(75) Inventor: Luiz M. Franca-Neto, Portland, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/739,833

(22) Filed: Dec. 18, 2003

(51) Int. Cl. G06G 7/62

(52) U.S. Cl. 333/247

(57) ABSTRACT

An apparatus and a system, as well as a method and an article, may include operating a processor included in a die having a plurality of scalable amplifier circuits in electrical communication with the processor and with a non-scalable power addition circuit to couple to a common antenna structure.

### RELATED APPLICATIONS

This disclosure is related to pending U.S. patent application Ser. No.______, titled “Component Packaging Apparatus, Systems, and Methods”, by Luiz M. Franca-Neto, filed on ______ , and is assigned to the assignee of the embodiments disclosed herein, Intel Corporation.

### TECHNICAL FIELD

Various embodiments described herein relate to component packaging generally, including apparatus, systems, and methods for packaging and operating active components, including amplifiers and transistors.

### BACKGROUND INFORMATION

The task of integrating radio frequency (RF) circuitry, including transceivers, and digital circuitry, including microprocessors, on the same die presents several challenges. First, there may be a difference in signal levels between the two types of circuits of several orders of magnitude. Second, a conflict may arise between the die surface area consumed by the processor and that required by the RF circuitry, especially large passive components.

A third challenge involves radio transmissions at elevated power levels, where relatively large voltage swings on the terminals of the transmitting antenna are desired. Such changes in voltage may not be tolerated by certain transistors, including complementary metal-oxide semiconductor (CMOS) transistors, and the maximum tolerable transistor voltage excursions may diminish as the circuit scale is reduced.

### BRIEF DESCRIPTION OF THE DRAWINGS

FIG. 1 is a block diagram of an apparatus including a die, a package structure, and an electronic assembly according to various embodiments;

FIG. 2 is a top view of an apparatus and a system according to various embodiments;

FIG. 3 is a partial schematic diagram of an apparatus and a system according to various embodiments;

FIGS. 4A and 4B are side views of a package and a die attached to a package, respectively, according to various embodiments

FIGS. 5A and 5B are flow charts illustrating several methods according to various embodiments; and

FIG. 6 is a block diagram of an article according to various embodiments.

### DETAILED DESCRIPTION

Various embodiments disclosed herein address some of the challenges described above by moving inductors and other passive, non-scalable components typically found in RF circuitry, including RF and microwave transmitters, receivers, and transceivers, from the die to a package substrate. When this transition is made, the size requirements of the passive, non-scalable components may be more compatible with the available area.

Power addition may also be implemented on the package substrate. In this manner, low-loss passive circuitry capable of adding the outputs of several on-die power amplifiers operating in parallel may be realized on the substrate, enabling relatively high-power transmission with low voltage devices, including CMOS transistors. Thus, in some embodiments of the invention, RF chokes, impedance transformers, and power addition circuitry can be used to couple several RF power amplifiers and a processor to a single antenna structure, all within a single package, providing communications systems that scale with technology.

In some embodiments, some or all of the passive components may be constructed using package traces, including microstrip or stripline structures. This type of construction may even obviate the need for mounting discrete components on the substrate, providing a more cost-effective solution. In some embodiments, only active components, such as transistors, are left on the die, and thus full advantage of scaling may be taken with respect to all of the on-die components.

For the purposes of this document, a “scalable” component is a component of an electronic RF circuit that is capable of being scaled in substantially direct proportion to transistors on the die as complementary metal-oxide semiconductor (CMOS) technology advances to provide shorter gate lengths without adversely affecting the performance of the RF circuit which includes it, at least a portion of the RF circuit being located on the die.

An “active” component is a component of an electronic circuit, including a radio frequency circuit, that includes an element that provides power gain, such as a transistor or diode. A “passive” component is a component of an electronic circuit, including a radio frequency circuit, that does not provide gain, such as an inductor formed exclusively from metal, a conventional capacitor formed by placing metallic plates adjacent dielectric material, and a conventional carbon-film resistor, for example.

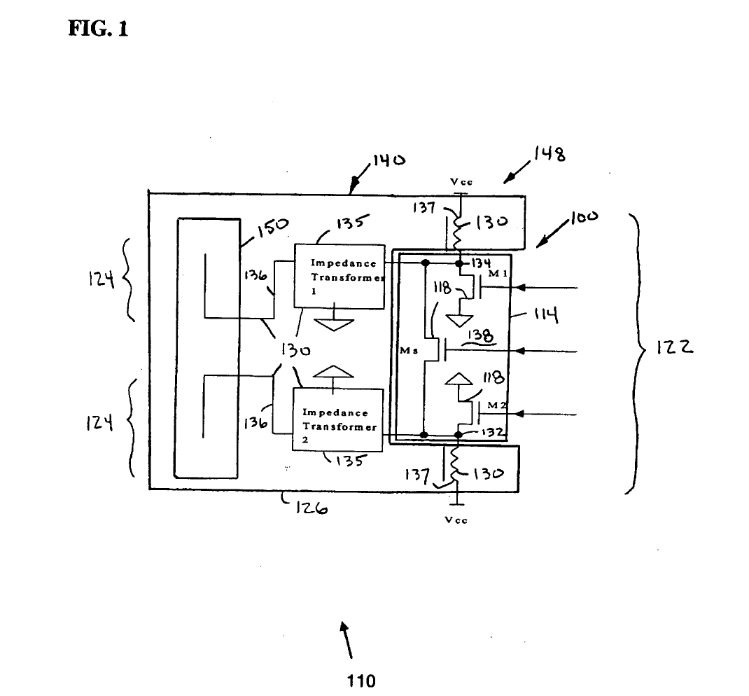

FIG. 1 is a block diagram of an apparatus 100 including a die, a package structure, and an electronic assembly according to various embodiments, each of which may operate in the manner described above. In this case a generalized concept of several embodiments of the invention may be seen, wherein an apparatus 100 may include a die 114 having one or more scalable components 118 of a circuit 122. The apparatus 100 may also include a structure 126, such as a package substrate, having one or more non-scalable components 130 of the circuit 122. The die 114 may be fabricated so that it does not include any non-scalable components 130 of the circuit 122.

As a more specific exemplary embodiment, assume the circuit 122 includes one or more non-scalable components 130 located on the structure 126. The structure 126, in turn, may include a substrate, and the combination of the die 114 and the structure 126 may form a portion of a package, including a flip-chip package. Power, ground, and other signals may be routed from the external world to the circuit 122 via a variety of nodes 132, 134, which may include controlled collapse chip connections. The non-scalable components 130 may include one or more impedance transformers 135, transmission lines 136, and inductors 137, including RF chokes. A common antenna structure 150 may be located on or off the structure 126, and it may be coupled to the circuit 122, including a power addition portion 124 of the circuit 122.

Even though this particular example relates to power amplifier (PA) design, it should be noted that other functional blocks (e.g., voltage-controlled oscillators, power amplifiers, mixers, etc.) of receivers, transmitters, and transceivers can be realized by coupling on-die, active scalable components 118, such as on-die transistors and diodes, with on-structure passive, non-scalable components 130, such as shunting inductors located on the structure 126.

Thus, in some embodiments, an apparatus 100 may include a die 114 having a plurality of nodes 132, 134, including terminals, such as controlled collapse chip connections, on at least one surface 138 of the die 114 to couple to a structure 126. The structure 126, such as a package substrate, may include one or more power addition circuits 124 to couple the plurality of active scalable components 118 located on the die 114 to a common antenna structure 150.

The scalable components 118 may include one or more diodes, and/or transistors, including FETs (field effect transistors). Non-scalable components 130 may include one or more transformers 135, transmission lines 136, inductors 137, capacitors, and/or resistors, each of which may in turn include one or more traces (e.g., microstrip or striplines) forming a part of the structure 126. The circuit 122 may include one or more of a transceiver, a transmitter, a receiver, an amplifier (e.g., a PA), a synthesizer, an oscillator, and a mixer, among other RF circuit elements.

Given the definitions of scalable and non-scalable components detailed previously, many embodiments may be realized. For example, an apparatus 100 may include a package structure 140 having a structure 126, such as a package substrate to couple to a die 114 having a plurality of active scalable components 118, as well as one or more power addition circuits 124, which may be made up of entirely passive components, to couple to the plurality of active scalable components 118. The structure 126 may include a flip-chip package substrate. The power addition circuits 124 may include one or more of a transmission line, an inductor, and a transformer.

In some embodiments, an apparatus 100 may also include an electronic assembly 148 having a die 114 with a plurality of active scalable components 118 included in a circuit 122, as well as a structure 126, such as a package substrate having one or more power addition circuits 124, including passive power addition circuits, to couple to the plurality of active scalable components 118. The electronic assembly 148 may be constructed so that the structure 126 does not include another scalable component 118 of the circuit 122. The die 114 may be attached to the structure 126 with one or more nodes 132, 134, such as controlled collapse chip connections. Still other embodiments may be realized.

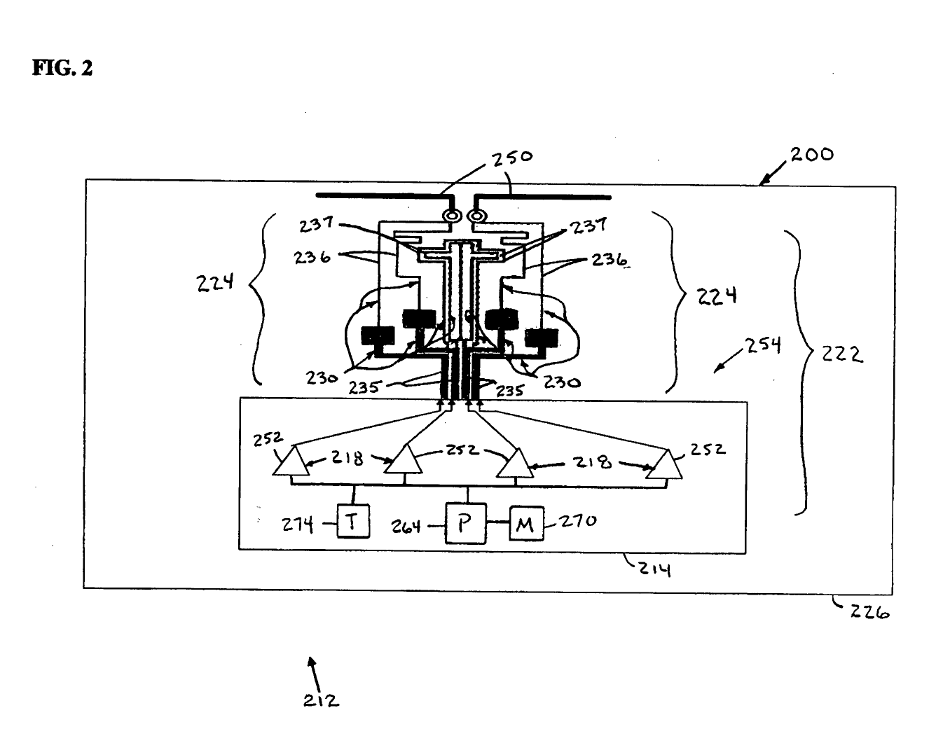

For example, FIG. 2 is a top view of an apparatus 200 and a system 212 according to various embodiments. The apparatus 200 may be similar to or identical to the apparatus 100 (see FIG. 1). Thus, in some embodiments, an apparatus 200 may include a die 214 having one or more scalable components 218 of a circuit 222, as well as a structure 226 (e.g., a package substrate) having one or more non-scalable components 230 of the circuit 222. The die 214 may be fabricated so that it does not include any non-scalable components 230 of the circuit 222, and the structure 226 may be fabricated so that it does not include any scalable components 218 of the circuit 222.

As a more specific exemplary embodiment, assume the circuit 222 includes a number of active scalable components 218, such as a selected number of PAs 252. The non-scalable components 230 in this case may include passive components, such as impedance transformers 235, transmission lines 236, and inductors 237, such as RF chokes, perhaps being formed entirely by traces or microstrips located on the structure 226, such as a package substrate, including a flip-chip package substrate.

In this example, the power output of the PAs 252 may be combined by using a series of passive, non-scalable components 230, enabling high-power RF transmission even though the PA design may be limited to a series of low-voltage transistors, such as CMOS devices. In some embodiments, a multi-band radio transceiver 254 may be integrated on the same die 214 with a general purpose processor 264, wherein all passive components 230, including passive non-scalable components, are located on the substrate 226. The general purpose processor 264 may communicate with the radio transceiver 254 through a memory 270 buffer.

Thus, any number of non-scalable components 230 may be included in one or more power addition circuits 224. For example, the power addition circuits 224 may include one or more of a ¼ wave transmission line 236 and an impedance transformer 235, which may in turn be formed as microstrips on the structure 226. The power addition circuitry 224 may be entirely passive.

As shown in FIG. 2, the power addition circuitry 224 may enable relatively high power RF transmission using low-voltage transistors on the die as part of a PA 252 design. In the illustrated case, the output of four PAs 252 are combined at a common antenna structure 250, which may include one or more dipole antennas.

To accommodate radio coverage requirements for high transmitted power, as well as the relatively low voltages utilized by advanced CMOS transistors, PA designs may be realized using a two-fold strategy: adding the power of several low voltage PAs, and using power-efficient (i.e., low-loss) impedance transformation from the antenna to the drain of individual CMOS PA transistors. Thus, the total output power to the antenna structure 250 may be taken as N*(V²/R), where N is the number of PAs 252 subject to power addition, and R is the impedance to which the antenna's impedance is transformed. The larger the value of N, and the lower the value of R, the greater will be the radiated power.

Referring back to FIG. 1, it can be seen that using an odd number of ¼ wavelength transmission lines 136, corresponding to a microstrip extension of the respective impedance transformers 135, may operate to effectively isolate the drain nodes of the scalable components 118, such as PA transistors, and provide independent voltage sources. Due to the relative linearity of microstrip behavior (e.g., metal traces), the drain nodes may operate as alternating current grounds, which appear as open circuits at the base of the antenna structure 150. Thus, referring back to FIG. 2, it can be seen that the base of the antenna itself may operate to add the output voltages from the PAs 252. Transmitted power control may be implemented by turning individual PAs 252 on or off as desired, due to the isolation described.

Making use of the mechanism disclosed, the output of each PA 252 may be selectively added as desired. Of course, those skilled in the art will realize, after reading this disclosure, that the amount of power addition is not without limit, and close attention should be paid to the parallel impedance combination as seen at the base of the antenna structure 250. Thus, using the principles described herein one or more passive power addition circuits 224 may be used to provide a fully integrated communications system within a flip-chip package, using inductors 237, such as RF chokes, and high impedance transformers 235 by adding the output power of several RF PAs 252 integrated on a silicon die 214.

As is the case with the apparatus 100 in FIG. 1, and the apparatus 200 in FIG. 2, the system 212 may include an antenna structure 250, having one or more monopole, dipole, patch, and/or omnidirectional antennas, as well as combinations of these. The antenna structure 250 may be directly coupled to the circuit 222. The system 212 may also include a memory 270 coupled to the processor 264, and the circuit 222. The circuit 222, in turn, may include one or more of a receiver, transmitter, and/or a transceiver, such as a data transceiver. The circuit 222 may form a portion of a cellular telephone or a wireless local area network (LAN) transceiver.

Thus, a system 212 may include a die 214 having a plurality of active scalable components 218 included in a circuit 222, and a structure 226, such as a package substrate having one or more power addition circuits 224 to couple to the plurality of active scalable components 218. The system 212 may include a common antenna structure 250 to couple to one or more of the power addition circuits 224, and the common antenna structure 250 may include one or more dipole antennas.

In addition, the plurality of active scalable components 218 in the system 212 may include a selected number of scalable amplifier circuits 252. The system 212 may include a transmitter 274 to couple to the plurality of scalable amplifier circuits 252, and the die 214 may include one or more processors 264 coupled to the plurality of active scalable components 218.

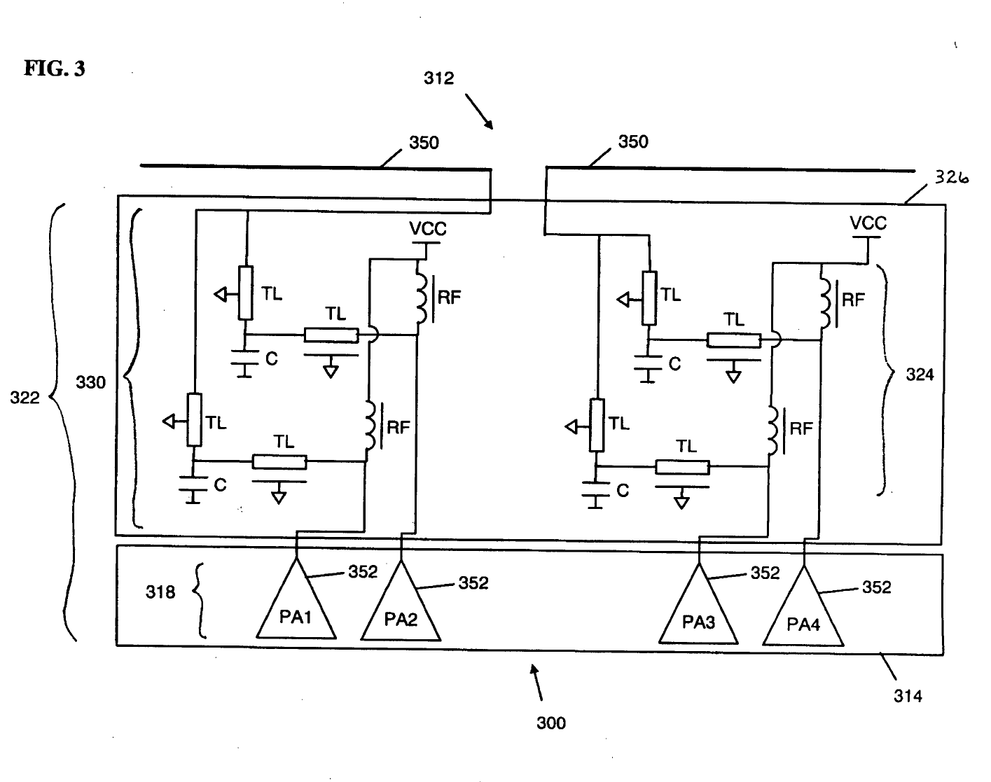

FIG. 3 is a partial schematic diagram of an apparatus 300 and a system 312 according to various embodiments. The apparatus 300 may be similar to or identical to the apparatus 200 (see FIG. 2), and the system 312 may be similar to or identical to the system 212 (see FIG. 2). Thus, in some embodiments, an apparatus 300 may include a die 314 having one or more scalable components 318 of a circuit 322, as well as a structure 326 (e.g., a package substrate) having one or more non-scalable components 330 of the circuit 322. The die 314 may be fabricated so that it does not include any non-scalable components 330 of the circuit 322, and the structure 326 may be fabricated so that it does not include any scalable components 318 of the circuit 322.

As a more specific exemplary embodiment, assume the circuit 322 includes a number of active scalable components 318, such as a selected number of PAs 352. The non-scalable components 330 in this case may include passive components, such as impedance transformers, capacitors C, transmission lines TL, and inductors RF, perhaps being formed entirely by traces or microstrips located on the structure 326, such as a package substrate, including a flip-chip package substrate.

In this example, the power output of the PAs 352 may also be combined by using a series of passive, non-scalable components 330, as described previously. The output of four PAs 352 may be combined at a common antenna structure 350, which may include one or more dipole antennas.

As noted previously, any number of non-scalable components 330 may be included in one or more power addition circuits 324. For example, the power addition circuits 324 may include one or more of a ¼ wave transmission line TL and an impedance transformer, which may in turn be formed as microstrips on the structure 326. The power addition circuitry 324 may be entirely passive.

As shown in FIG. 3, the power addition circuitry 324 includes four impedance transformers. Other numbers may be used. Each impedance transformer may include a combination of lumped and distributed components. For example, as seen in FIG. 3, each impedance transformer may be implemented as a capacitor C and a first transmission line TL that couples the capacitor C to a PA 352. Thus, a 50 ohm complex antenna impedance may be reduced by the combination of the capacitor C (lumped) and the first transmission line TL (distributed) to a real value of about 5 ohms. The second transmission line TL that couples the capacitor C to the antenna structure 350 may be a ¼ wavelength line that is used to enable coupling the parallel combination of PAs 352 at the antenna structure 350. If only one PA 352 is connected to the antenna structure 350, then the second transmission line TL might be eliminated, and the antenna structure 350 could be connected directly to the junction between the first transmission line TL (which may also be a ¼ wavelength line) and the capacitor C. As an additional aid to understanding some of the embodiments which may be implemented, details of a potential packaging format will now be shown.

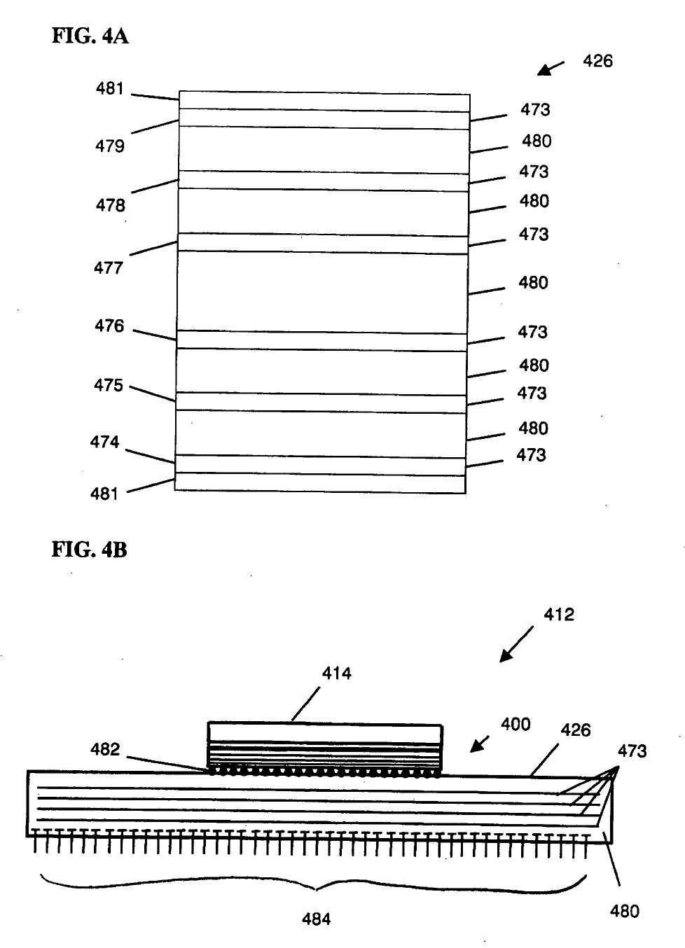

FIGS. 4A and 4B are side views of a package and a die attached to a package, respectively, according to various embodiments. As seen in FIG. 4A, the package 426 may include six conductor layers 473 (other numbers of layers 473 may be used). These conductor layers 473 may include a first power layer 474, a connection routing layer 475, a second power layer 476, a first RF trace layer 477, a ground plane layer 478, and a second RF trace layer 479, among others. Above, below, and between the conductor layers may be located dielectric layers 480 and solder mask layers 481.

Non-scalable components (not shown) may be included in the package 426, including on the first and second RF trace layers 477, 479. Nodes, similar to or identical to the nodes 132, 134, 136 (see FIG. 1) may be included in controlled collapse chip connections 482, and may be used to couple and/or attach the package 426 to the die 414, as shown in FIG. 4B. The die 414 and the package 426 may be used separately or together to implement various versions of the apparatus 400 and systems 412 (similar to or identical to the apparatus 100, 200, 300 and system 212, 312 shown in FIGS. 1, 2, and 3, respectively) described herein. Package pins 484 may be used to couple the package 426 to another circuit, such as a processor socket in a motherboard.

The apparatus 100, 200, 300, 400, systems 212, 312, 412, dice 114, 214, 314, 414, scalable components 118, 218, 318, circuits 122, 222, 322, power addition circuits 124, 224, 324, structures 126, 226, 326, 426, non-scalable components 130, 230, 330, nodes 132, 134, impedance transformers 135, 235, transmission lines 136, 236, TL, inductors 137, 237, RF, surface 138, package structure 140, electronic assembly 148, antenna structures 150, 250, 350, amplifiers 252, transceiver 254, processor 264, memory 270, transmitter 274 , conductor layers 473, power layers 474, 476, routing layer 475, RF trace layers 477, 479, dielectric layers 480, solder mask layers 481, chip connections 482, and capacitors C may all be characterized as “modules” herein. Such modules may include hardware circuitry, and/or a processor and/or memory circuits, software program modules and objects, and/or firmware, and combinations thereof, as desired by the architect of the apparatus 100, 200, 300, 400, and systems 212, 312, 412, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, and/or a combination of software and hardware used to simulate the operation of various potential embodiments.

It should also be understood that the apparatus and systems of various embodiments can be used in applications other than for cellular telephones, and other than for systems that include wireless data communications, and thus, various embodiments are not to be so limited. The illustrations of apparatus 100, 200, 300, 400, and systems 212, 312, 412 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as, televisions, cellular telephones, personal computers, workstations, radios, video players, vehicles, and others. Some embodiments include a number of methods.

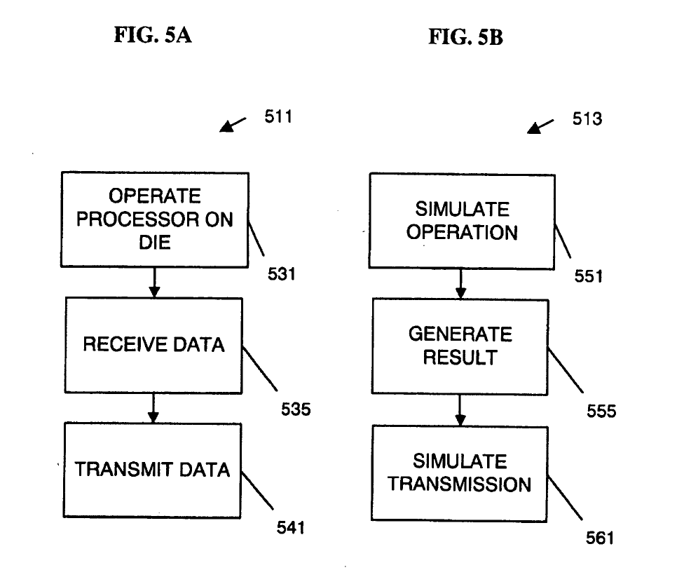

For example, FIGS. 5A and 5B are flow charts illustrating several methods 511, 513 according to various embodiments. For example, in some embodiments of the invention, a method 511 may (optionally) begin at block 531 with operating a processor included in a die having a plurality of scalable amplifier circuits in electrical communication with the processor and with a non-scalable power addition circuit to couple to a common antenna structure. The method 511 may continue with operating a transmitter coupled to the plurality of scalable amplifier circuits, wherein the transmitter receives data from the processor at block 535. The method 511 may include transmitting the data received from the processor using the plurality of scalable amplifier circuits at block 541.

As noted above, the die may comprise any number of circuits, including RF circuits, one or more processors and/or one or more memories. Thus, simulations of the methods described herein may be useful to the designer of the apparatus and systems disclosed. The results of such simulations may include analyses of the noise levels present in the structure and/or die, especially with respect to operational signal levels present within the circuit, such as an RF circuit, and processors and/or memory that may be included on the die. The results may also include analyses of power usage and efficiency, operational speeds, and sensitivity of various circuit parameters with respect to scaling of the scalable components on the die.

Therefore, a method 513 may include simulating operating a processor included in a die having a plurality of scalable amplifier circuits in electrical communication with the processor and with a non-scalable power addition circuit to couple to a common antenna structure at block 551, and generating a result, such as a human-perceivable result, of the simulating at block 555. As noted previously, the die may include a processor coupled to the circuit, and the processor may operate to share data with the circuit. Therefore, the method 513 may include simulating transmitting data generated by the processor using the plurality of scalable amplifier circuits at block 561.

The human-perceivable result may include an analysis of power applied to the common antenna structure at an output of the power addition circuit. The human-perceivable result may also include an analysis of a signal level associated with the processor and the plurality of scalable amplifier circuits.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML). Thus, other embodiments may be realized.

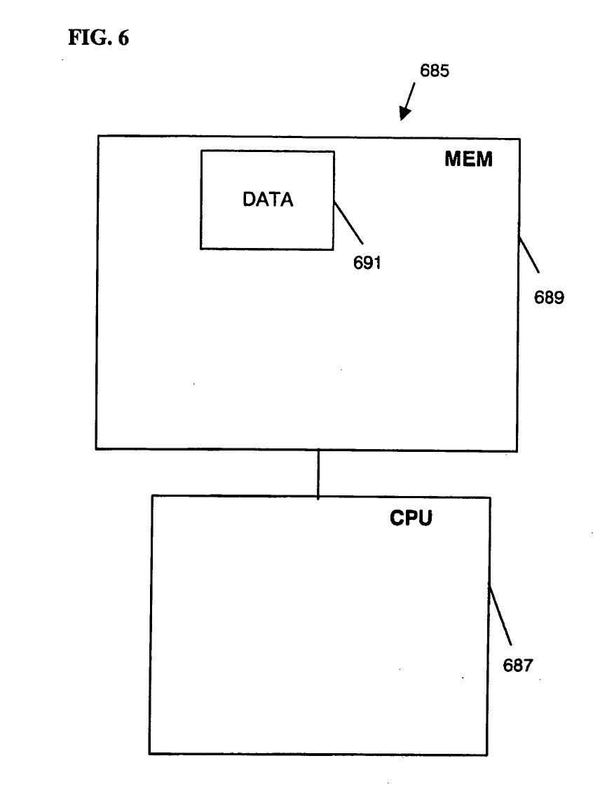

FIG. 6 is a block diagram of an article 685 according to various embodiments, such as a computer, a memory system, a magnetic or optical disk, some other storage device, and/or any type of electronic device or system. The article 685 may include a processor 687 coupled to a machine-accessible medium such as a memory 689 (e.g., a memory including an electrical, optical, or electromagnetic conductor) having associated information 691 (e.g., computer program instructions and/or data), which when accessed, results in a machine (e.g., the processor 687) performing such actions as simulating operating a processor included in a die having a plurality of scalable amplifier circuits in electrical communication with the processor and with a non-scalable power addition circuit to couple to a common antenna structure, and generating a human-perceivable result of the simulating. Other activities may include simulating transmitting data generated by the processor using the plurality of scalable amplifier circuits. As noted above, the human-perceivable result may include an analysis of power applied to the common antenna structure at an output of the power addition circuit, as well as an analysis of a signal level associated with the processor and the plurality of scalable amplifier circuits.

Improved integration of RF circuitry, including scalable portions of transceivers, power amplifiers, and digital processors on the same die may result after implementing the apparatus, systems, and methods disclosed herein. Since some embodiments may have only transistors remaining on-die, the production of high-performance, high-power CMOS integrated radios may be realized, including fully-scalable dice forming part of a single package, such as a flip-chip package.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A die, including:
a plurality of active scalable components; and
a plurality of nodes on at least one surface of the die to couple to a package substrate including a power addition circuit to couple to the plurality of active scalable components located on a die to a common antenna structure.

2. The die of claim 1, wherein the power addition circuit includes at least one ¼ wave transmission line and an impedance transformer.

3. The die of claim 1, wherein the at least one ¼ wave transmission line and the impedance transformer are formed as microstrips on the package structure.

4. The die of claim 1, wherein the power addition circuit is a passive power addition circuit.

5. The die of claim 1, wherein selected ones of the plurality of scalable active components include a power amplifier.

6. A package structure, including:
a package substrate to couple to a die having a plurality of active scalable components; and
a passive power addition circuit to couple to the plurality of active scalable components.

7. The package structure of claim 6, wherein the package substrate includes a flip-chip package substrate.

8. The package structure of claim 6, wherein the power addition circuit includes at least one of a transmission line, an inductor, and a transformer.

9. An electronic assembly, including:
a die having a plurality of active scalable components included in a circuit; and
a package substrate having a passive power addition circuit to couple to the plurality of active scalable components.

10. The electronic assembly of claim 9, wherein the package substrate does not include another scalable component of the circuit.

11. The electronic assembly of claim 9, wherein the die is attached to the package substrate with at least one controlled collapse chip connection.

12. The electronic assembly of claim 9, wherein the plurality of scalable components includes at least one transistor.

13. The electronic assembly of claim 9, wherein the passive power addition circuit includes at least one of a transformer, a transmission line, and an inductor.

14. A system, including:
a die having a plurality of active scalable components included in a circuit;
a package substrate having a power addition circuit to couple to the plurality of active scalable components; and
a common antenna structure to couple to the power addition circuit.

15. The system of claim 14, wherein the common antenna structure includes at least one dipole antenna.

16. The system of claim 14, wherein the plurality of active scalable components includes a plurality of scalable amplifier circuits.

17. The system of claim 14, further including: a transmitter to couple to the plurality of scalable amplifier circuits.

18. The system of claim 14, wherein the die further includes a processor coupled to the plurality of active scalable components.

19. A method, including:
operating a processor included in a die having a plurality of scalable amplifier circuits in electrical communication with the processor and with a non-scalable power addition circuit to couple to a common antenna structure.

20. The method of claim 19, further including:
operating a transmitter coupled to the plurality of scalable amplifier circuits, wherein the transmitter receives data from the processor.

21. The method of claim 19, further including:
transmitting data received from the processor using the plurality of scalable amplifier circuits.

22. An article comprising a machine-accessible medium having associated information, wherein the information, when accessed, results in a machine performing:
simulating operating a processor included in a die having a plurality of scalable amplifier circuits in electrical communication with the processor and with a non-scalable power addition circuit to couple to a common antenna structure; and
generating a human-perceivable result of the simulating.

23. The article of claim 22, wherein the human-perceivable result includes an analysis of power applied to the common antenna structure at an output of the power addition circuit.

24. The article of claim 22, wherein the human-perceivable result includes an analysis of a signal level associated with the processor and the plurality of scalable amplifier circuits.

25. The article of claim 22, wherein the information, when accessed, results in the machine performing:
simulating transmitting data generated by the processor using the plurality of scalable amplifier circuits.
